(19) United States
(12) Patent Application Publication
(10) Pub. No.: US 2015/0215127 A1
(43) Pub. Date: Jul. 30, 2015

(54) Method of Secure Communication Utilizing a Cryptographic Neural Implant for Reception of Visual System Signals

(71) Applicant: Neurocryptonics Innovations L.L.C., Baton Rouge, LA (US)

(72) Inventor: Carl Frederick Sabottke, Baton Rouge, LA (US)

(73) Assignee: Neurocryptonics Innovations L.L.C., Baton Rouge, LA (US)

(21) Appl. No.: 14/164,239

(22) Filed: Jan. 26, 2014

(51) Int. Cl. H04L 9/14; G06N 3/06

(52) U.S. Cl. CPC H04L 9/14; G06N 3/061; H04L 2209/24

(57) ABSTRACT

A method for the secure communication of sensitive information in which the receiver of the sensitive information is equipped with a neural implant capable of stimulating the visual system of a mammalian brain. In this method, a transmitting party encrypts an image or a sequence of images and sends them to a computational device or devices securely connected to the receiving party's neural implant. The computational device or devices then decrypt the image or sequence of images and perform further mathematical operation on the image or images in order to convert them into a stimulation pattern that approximates the neural code of the neuron or neurons most directly affected by stimulation patterns which are produced by the neural implant apparatus.

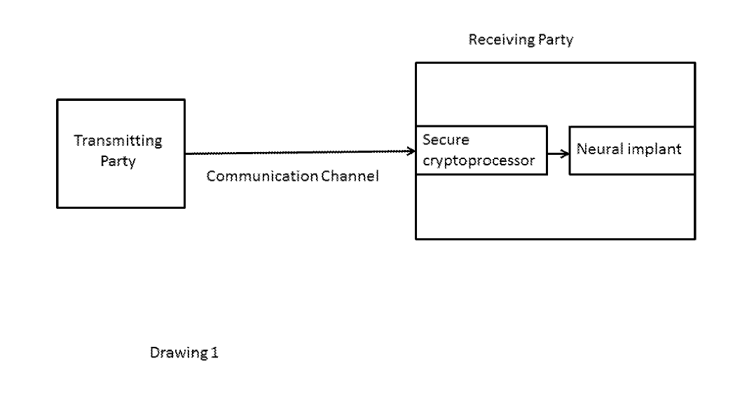

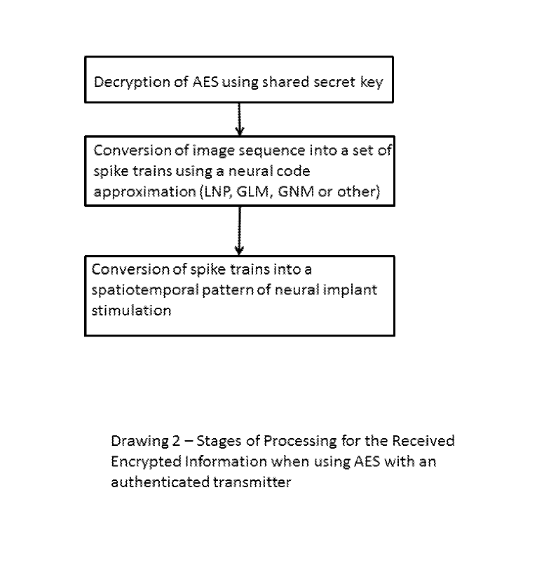

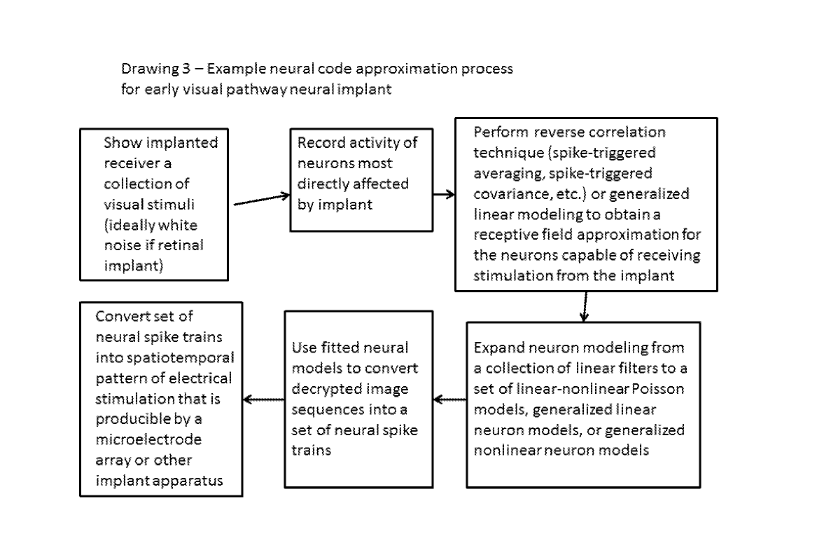

### CROSS-REFERENCE TO RELATED APPLICATIONS

Not Applicable

### STATEMENT REGARDING FEDERALLY SPONSORED RESEARCH OR DEVELOPMENT

Not Applicable

### REFERENCE TO SEQUENCE LISTING, A TABLE, OR A COMPUTER PROGRAM LISTING COMPACT DISC APPENDIX

Not Applicable

### BACKGROUND OF THE INVENTION

The present invention combines cryptographic protocols, neural implants, and knowledge of the neural code of biological neurons in order to generate a novel method for secure communication. In the prior art, cryptographic protocols generally involve using either asymmetric key algorithms, symmetric key algorithms or a combination of the two. Asymmetric key encryption algorithms, like the popular Rivest, Shamir, and Adelman (RSA) algorithm, enable the secure sharing of information due to asymmetry in the difficulty of performing certain mathematical operations. For example, multiplying two large prime numbers together is relatively inexpensive from a computational perspective. However, unless the two primes are already known, then factoring the product into the original two large primes presents a significantly more difficult computational challenge. The computational difficulty of the inverse operation is where a scheme like RSA derives its security.

Asymmetric algorithms are advantageous over symmetric algorithms, because, through the use of different public and private keys, they do not require two communicating parties to have a private shared secret before initiating secure communication. However, the development of Shor's algorithm has shown that the security of asymmetric algorithms like RSA is vulnerable to quantum computation. This increases the appeal of symmetric key algorithms like the Advanced Encryption Standard (AES). Yet, the requirement that these algorithms have the transmitting and receiving parties share an initial secret still poses a problem.

Quantum key distribution schemes seek to solve this shared secret problem by using the principles of quantum physics to ensure that an eavesdropper does not have access to a sequence of quantum bits that is shared along a quantum channel. One possible implementation is to use the decoy state variant of the 1984 Bennett and Brassard protocol (BB84). Other schemes, including variants of the 1991 Ekert protocol (E91), use quantum entanglement to ensure the security of the secret key distribution. Furthermore, artificial neural networks (ANNs) have also been proposed as another possible way to generate shared secret information between two parties through synchronization of two artificial neural networks.

However, classical cryptography schemes, quantum key distribution protocols, and current neurocryptography schemes do not solve the problem of needing a secure area for decryption. In most security analyses, it is assumed that the transmitter and the receiver have a security area immediately surrounding them in which they can deal with the sensitive information in a plaintext or other unencrypted form. However, in practice, this assumption is flawed. For example, it does not matter what kind of encryption a bank uses. An ATM pin can still be stolen by a stranger looking over person's shoulder when he or she is in the process of entering the pin into the machine. By the same token, if sensitive information is securely sent to a person's computer and displayed in a decrypted form after a password is entered into the device as part of a challenge-response authentication protocol, then the sensitive information can still be accessed by an eavesdropper if a device such as a camera is placed so that it has a view of the computer's monitor. This type of attack is known as “shoulder surfing,” and it is a critical weakness of many secure communication schemes which overlook the practical difficulties that exist in ensconcing a receiving party in a secure area for decrypting and reading sensitive information. The present invention improves over the prior art by developing a novel method of secure communication which is highly resistant to typical shoulder surfing attacks.

The present invention relies on the receiver of the secure communication being equipped with a neural implant. In the prior art, neural implants are used as medical devices. For the case of vision, electrodes are implanted in an area of the early visual pathway, such as the retina, and stimulate the neurons in the surrounding area to generate visual percepts. These implants are designed to restore sight to those who have become blind due to retinal diseases such as macular degeneration. However, the present invention, in a novel manner, utilizes neural implants not for a medical purpose, but instead as a means of engaging in a highly secure communication protocol that is resistant to the shoulder surfing attacks which can compromise any existing cryptographic protocol in which the terminal receiver of the secure communication is a biological organism (e.g. a human).

### BRIEF SUMMARY OF THE INVENTION

Although it has not been considered in the prior art, with proper modifications, neural implants can be used for non-medical purposes as a means of solving the problem of needing a secure area for dealing with sensitive information in a decrypted form. The method disclosed here explicates how to exploit the neural code of biological neurons, so that encrypted information sent to a biological receiver does not ever need to be exposed beyond the confines of a secure cryptoprocessor or hardware security module in an explicitly decrypted plaintext form. In brief summary, this novel secure communication method involves an authenticated transmitting party sending encrypted images (which can contain text or even be compromised entirely of text) to a secure cryptoprocessor that belongs to the receiving party. The images containing the sensitive information can be encrypted using essentially any algorithm such as AES, RSA, Threefish, or Twofish. The main innovation of the present secure communication method is that the secure cryptoprocessor, which belongs to the receiving party, does not output the decrypted images in their original form, and, instead, the secure cryptoprocessor is connected to a neural implant. The secure cryptoprocessor uses biological neural coding models, such as generalized linear models, and outputs the images as a spatiotemporal pattern of electrical stimulation that is specific to the neurons affected by the receiving party's neural implant. Thus, the receiving party's secure cryptoprocessor decrypts the images and then encrypts them using the neural code of the neurons affected by the receiving party's implant.

### BRIEF DESCRIPTION OF THE SEVERAL VIEWS OF THE DRAWINGS

Drawing 1 shows an overall schematic of the novel secure communication method. An authenticated transmitting party telemetrically sends an encrypted signal to a secure cryptoprocessor attached to a receiving party's neural implant which can stimulate neurons in the visual system. The secure cryptoprocessor decrypts the signal and then uses neural coding models to convert the decrypted images into a spatiotemporal stimulation pattern which is interpretable by the neurons in the receiving party's brain.

Drawing 2 shows a more detailed schematic for the processes carried out on the receiver's side of this communication scheme. Here, as an example, the transmitter's AES encryption is decrypted on the secure cryptoprocessor. Then, neural coding models such as linear-nonlinear Poisson models, generalized linear models, or generalized nonlinear models are used to filter the images and produce spike trains which are then converted into stimulation patterns producible by the neural implant.

Drawing 3 diagrams a receiver-side process for developing models for the neuron receptive fields after implantation.

### DETAILED DESCRIPTION OF THE INVENTION

Through the use of a neural implant placed along the nervous system pathway that compromises the mammalian visual system, encrypted images can be sent to a computational device and then decrypted. In previously existing secure communication methods, these decrypted images would be sent to a monitor for display purposes. However, in order to avoid the flawed assumption that the area around the receiver of the sensitive information is secure, we have developed a method for secure communication by which the decrypted images are not sent to a monitor or other display apparatus. Instead, the decrypted images are converted into a spatial and temporal pattern of electrical stimulation pulses which is producible by the neural implant embedded in the receiver's visual system. In this way, sensitive information contained in a sequence of images can be securely communicated to a recipient without having to make any assumptions about a large secure area existing around the recipient.

To utilize this method of secure communication, the best mode of practice is to use a multielectrode array as the stimulating apparatus and to implant the stimulating apparatus either in an epiretinal location or a location in the primary visual cortex (V1). If implanted in an epiretinal location, then primarily retinal ganglion cells will receive the most direct stimulation from the implant. However, the stimulation apparatuses useable with this method should not be considered limited to multielectrode arrays.

Additionally, retinal ganglion cells or cells in the primary visual cortex are not the only visual system neurons which can be stimulated with this method. Other neurons available include cells in the lateral geniculate nucleus or extrastriate visual cortex areas such as V2, V3, V4, and V5. However, epiretinal implantation is particularly advantageous, because retinal ganglion cells can be stimulated by a relatively less invasive implant. Also, since these cells are located at an early stage of the visual processing pathway in the mammalian nervous system, these retinal ganglion cells have more simplistic receptive fields than neurons which are located in more advanced areas of the visual pathway like V5, for example.

Neurons implanted with a multielectrode array or other stimulating apparatus can then possibly have their receptive fields mapped if the implant apparatus is also capable of recording the electrical potential in the area around the neurons which are most directly affected by the implant apparatus. Reverse correlation techniques such as spike-triggered averaging or spike-triggered covariance could then be used to obtain approximations of the receptive fields for the neurons most directly affected by the stimulation patterns produced by the implant apparatus. Generalized linear models and generalized nonlinear models can also be used in order to map neural receptive fields when both stimulus and neural spiking response information are available.

Mapping the neuron's receptive fields allows for the use of these receptive fields for filtering operations that can be performed on the decrypted images using a computational device attached to the wearable neural implant. However, the mapping process using reverse correlation is not completely necessary for the success of this method of secure communication, and, for example, an alternative approach would be to determine a set of receptive field type filters in advance for the neurons most directly affected by the implant using a statistical examination of a large group of data collected from previous recordings of a similar brain region.

Modeling and mapping the receptive fields of the neurons most directly affected by the stimulating apparatus allows for the use of a linear-nonlinear Poisson or other type of neural model to be used to approximate the neural circuitry in the visual pathway which is bypassed by the neural implant. Modeling this circuitry allows for the conversion of the decrypted images into several neural spike trains. These spike trains can then be converted into a series of electrical pulses which is producible by the implanted multielectrode array or other implant apparatus in use. This conversion process can be done on a computational unit which is attached to the wearable neural implant.

It should be noted, though, that a linear-nonlinear Poisson model is not necessarily the best model to use for these circuitry approximations, depending on the precision that is needed for the conversion process. The prior art for non-cryptographic neural implants with medical applications contains an example of a retinal implant study by Nirenberg and Pandarinath in 2012 which found that the linear-nonlinear Poisson model was an efficient means of approximating the bypassed circuitry. Work with a model that also considers coupling interactions between the neurons did not show a significant improvement. However, this medical retinal implant study did not investigate the more precise, generalized nonlinear neural modeling framework developed by Butts et al. in 2011. Thus, a best mode implementation of this method of secure communication would potentially choose to substitute a more precise GNNM for a LNP model of the neurons, even though it is still likely that it would be best to exclude coupling from this modeling and treat the neuron encoding as independent for the sake of efficiency.

As an alternative to an epiretinal implant, a primary visual cortex implant would not obscure any area of the visual field that is used as part of normal sight for the mammalian recipient. However, since the receptive fields of cells in V1 are generally more complex than the receptive fields of retinal ganglion cells, it can be more difficult to map the receptive fields of cells in V1 than it is to map retinal ganglion cells. Nevertheless, receptive field maps are still readily obtainable for V1 cells using reverse correlation techniques. It is also still possible to use neural models like the linear-nonlinear Poisson model, the generalized linear model, or the generalized nonlinear neural model as a means of converting the decrypted image data into spike trains and electrical pulse sequences that are representative of the image data when processed by neurons in the primary visual cortex.

The two main possibilities for encryption and decryption are asymmetric key algorithms and symmetric key algorithms. Asymmetric key algorithms, like RSA, are typically less secure from a computational perspective than symmetric key algorithms like the Advanced Encryption Standard (AES). However, algorithms like AES require a shared secret key between the transmitting and receiving parties. Ideally, though, the implant should allow for the use of the combination of digital signatures, public keys, private keys, and symmetric keys in the neural code augmented secure communication protocol that it performs.

The best mode implementation of this secure communication method is to connect the neural implant apparatus with wearable devices capable of performing decryption using at least one asymmetric key algorithm and at least one symmetric key algorithm. Ideally, these devices would be one or more secure cryptoprocessors that could be contained in a wearable hardware security module. Furthermore, the wearable devices capable of performing one or more symmetric and asymmetric key algorithms, in the best mode approach, should be capable of securely connecting or communicating with an additional apparatus which can receive transmissions from a secure quantum channel in order to generate a secret key according to a quantum key distribution (QKD) protocol, such as a decoy state variant of BB84. Alternatively to QKD, other means of distributing shared secrets could be utilized such as variants of the Diffie-Hellman key exchange protocol or one of the more recently developed schemes for key exchange that uses the synchronization of artificial neural networks as a means of distributing a shared secret between two remote parties.

In the best mode implementation of this method, the use of a robust authentication scheme is critical to the success of this method for achieving secure communication of sensitive information. Many different possible challenge-response authentication protocols could potentially be used to authenticate the identities of the communicating parties. In particular, though, the challenge-response authentication protocol employed by the communicating parties should defend against replay attacks through the use of cryptographic nonces, session tokens, time stamps, or a combination of these security measures. Authentication defenses against replay attacks are particularly important for this scheme because authenticated transmitters have the ability to cause stimulation of the receiver's brain. If the communication protocol does not use nonces or time stamps to filter out replay attack attempts at the level of the computational device or secure cryptoprocessor which is connected to the receiver's neural implant, then a particularly malicious eavesdropper could potentially use a series of replay attacks as a means of damaging the receiver's neural tissue through overstimulation of the neurons.

Damage to the receiver due to overstimulation of neural tissue could also potentially be caused, not only by a malicious eavesdropper, but also by a legitimate, but naïve transmitting party. Therefore, to ensure the safety of the receiver, a best mode implementation of this method would include a monitoring mechanism in a computational device attached to the receiving party's neural implant. This monitoring mechanism would halt stimulation if a high enough amount of activity and stimulation related to the implant has occurred in a chosen time interval so that it becomes probable that further stimulation would put the receiver's health at risk. This computational device would then send an encrypted response back to the original transmitter to inform the transmitting party that the message cannot be delivered until a future time. This time could, optionally, be specified in this encrypted message sent to the original transmitting party.

Even though it does not constitute the best mode of practice, it should also be noted that this method is operable even when there is a highly impoverished amount of information available about the receptive fields of the neurons that are most directly stimulated by the implant. In such a scenario, it is possible to securely transmit sensitive information by simplifying the sequence of transmitted images so that they lead to highly distinguishable patterns of neuronal stimulation. As a non-limiting and simplified example of this, we can consider a case in which two highly distinct image patterns are used to represent binary data that can be transmitted securely to the human recipient. Many distinct input patterns are possible, but in this non-limiting example, if we assume that the stimulating apparatus in the implant consists of a square multielectrode array, then one image could be used to represent 0 through the simultaneous stimulation of every microelectrode in the array within a small temporal window. Furthermore, an image that represents 1 could only activate a thin rectangular patch in the center of the microelectrode array. The perceptual differences between these two drastically different stimuli would allow for information to be communicated to the human recipient securely and with high fidelity even when the receptive field mapping information that is available to the transmitter is highly incomplete. Obviously, this example binary communication scheme would drastically reduce the channel capacity, but in a far from ideal scenario, it would still allow for this method of secure communication of sensitive information to be effective.

1. A secure method of communication for sensitive information comprising the steps of:
a. Having a mammalian recipient implanted with a device capable of stimulating one or more neurons in the recipient's brain that are associated with the processing of vision
b. Encrypting images with a symmetric key algorithm
c. Telemetrically sending the encrypted image data to a computational device attached to the mammalian recipient's neural implant
d. Decrypting the symmetric key encryption algorithm on a computational device attached to the mammalian recipient's neural implant
e. Using a computational device attached to the mammalian recipient's neural implant to convert the decrypted images into a spatial and temporal neural stimulation pattern that is then produced by the recipient's implant

2. The method of claim 1 where said neural implant stimulates retinal ganglion cells, neurons in the lateral geniculate nucleus, or the visual cortex.

3. The method of claim 1 where said neural implant stimulates neurons in the retina using a multielectrode array.

4. The method of claim 1 where the shared secret of said symmetric key algorithm is distributed through decoy state BB84 quantum key distribution.

5. The method of claim 1 where said neural implant stimulates neurons in the retina and the shared secret of said symmetric key algorithm is distributed through decoy state BB84 quantum key distribution.

6. The method of claim 1 where said neural implant stimulates neurons in the retina and the said conversion of decrypted images into a neural stimulation pattern uses a generalized linear model as a stage of processing performed on the images.

7. The method of claim 1 where the said conversion of decrypted images into a neural stimulation pattern uses a generalized linear neuron model as a stage of image processing.

8. The method of claim 1 where the said conversion of decrypted images into a neural stimulation pattern uses a generalized nonlinear neuron model as a stage of image processing.

9. The method of claim 1 where the said symmetric key algorithm is the Advanced Encryption Standard (AES).

10. A secure method of communication for sensitive information comprising the steps of:
a. Having a human recipient implanted with a device capable of stimulating one or more neurons in the recipient's retina
b. Encrypting images with the Advanced Encryption Standard (AES)
c. Telemetrically sending the encrypted image data to a computational device attached to the human recipient's neural implant
d. Decrypting AES on a computational device attached to the mammalian recipient's neural implant
e. Using a computational device attached to the human recipient's retinal implant to convert the decrypted images into a spatial and temporal neural stimulation pattern that is then produced by the recipient's implant

11. A secure method of communication comprising the steps of:
a. Having a mammalian recipient implanted with a device capable of stimulating one or more neurons in the recipient's brain that are associated with the processing of vision
b. Encrypting images using a public key with an asymmetric key algorithm
c. Telemetrically sending the encrypted image data to a computational device attached to the mammalian recipient's neural implant
d. Decrypting the asymmetric key encryption algorithm using a private key on a computational device attached to the mammalian recipient's neural implant
e. Using a computational device attached to the mammalian recipient's neural implant to convert the decrypted images into a spatial and temporal neural stimulation pattern that is then produced by the recipient's implant

12. The method of claim 11 where said neural implant stimulates retinal ganglion cells.

13. The method of claim 11 where said neural implant stimulates retinal ganglion cells using a multielectrode array.

14. The method of claim 11 where said neural implant stimulates neurons in the visual cortex.

15. The method of claim 11 where said neural implant stimulates neurons using a multielectrode array.

16. The method of claim 11 where the said conversion of decrypted images into a neural stimulation pattern uses a linear-nonlinear Poisson neuron model as a stage of image processing.

17. The method of claim 11 where the said conversion of decrypted images into a neural stimulation pattern uses a generalized linear neuron model as a stage of image processing.

18. The method of claim 11 where the said conversion of decrypted images into a neural stimulation pattern uses a generalized nonlinear neuron model as a stage of image processing.

19. The method of claim 11 where the said asymmetric key algorithm is the RSA (Rivest, Shamir, and Adleman) public key cryptography algorithm.
